(19) United States
(12) Patent Application Publication
(10) Pub. No.: US 2014/0251912 A1
(43) Pub. Date: Sep. 11, 2014

(54) Methods and Controllers for Simulated Moving Bed Chromatography for Multicomponent Separation

(71) Applicant: Georgia Tech Research Corporation, Atlanta, GA (US)

(72) Inventors: Gaurav Agrawal, Atlanta, GA (US); Yoshiaki Kawajari, Atlanta, GA (US)

(21) Appl. No.: 14/350,909

(22) PCT Filed: Oct. 11, 2012
(86) PCT No.: PCT/US2012/059776

§ 371 Date: Apr. 10, 2014

Related U.S. Application Data
(60) Provisional application No. 61/545,800, filed on Oct. 11, 2011.

(51) Int. Cl. B01D 15/02

(52) U.S. Cl. CPC B01D 15/02
USPC 210/656; 210/137

(57) ABSTRACT

A method of separating a feed mixture in a simulated moving bed includes flowing fluid in a first flow configuration comprising: supplying the feed mixture downstream of a valve in a shut off position that stops fluid flow to a first column, removing a raffinate stream component, and supplying a remaining fluid flow to a second column; supplying a desorbent to a third column and removing an extract stream downstream; and passing a remaining liquid flow through a fourth column, and removing an intermediate stream. The method includes flowing fluid in a second flow configuration in which the valve is in a position that permits fluid flow to the first column, and supplying a desorbent and removing an extract stream downstream from the column to which the desorbent is supplied; and removing a raffinate stream. The method includes flowing fluid in a third flow configuration in which the liquid flows through the first, second, third and fourth columns in an absence of a supply of additional feed mixture and an absence of a supply of additional desorbent to the liquid flow.

### RELATED APPLICATIONS

This application claims priority to U.S. Provisional Application Ser. No. 61/545,800, filed Oct. 11, 2011, the disclosure of which is hereby incorporated by reference in its entirety.

### FIELD OF THE INVENTION

The present invention relates to Simulated Moving Bed (SMB) chromatography, and more particularly, to SMB chromatography for multicomponent separation.

### BACKGROUND

Simulated Moving Bed (SMB) chromatography has emerged as a continuous and efficient technology for performing large scale chromatographic separations, particularly for the separation of binary mixtures. Compared to conventional chromatography, SMB enables high throughput and low desorbent consumption, and has been applied in various areas, such as sugar, petrochemical and pharmaceutical separations. The application of SMB chromatography to multi-component separation remains challenging in any chemical or bioprocessing industry where the need to separate and purify products from a complex mixture may be desired.

### SUMMARY OF EMBODIMENTS OF THE INVENTION

A method of separating a feed mixture in a simulated moving bed includes flowing fluid in a first flow configuration comprising: supplying the feed mixture downstream of a valve in a shut off position that stops fluid flow to a first column, removing a raffinate stream component downstream from the first column, and supplying a remaining fluid flow to a second column; supplying a desorbent to a third column that is downstream from the first column and removing an extract stream downstream from the third column; and passing a remaining liquid flow through a fourth column, and removing an intermediate stream comprising downstream from the fourth column. The method includes flowing fluid in a second flow configuration in which the valve is in a position that permits fluid flow to the first column, and supplying a desorbent to one of the columns and removing an extract stream downstream from the column to which the desorbent is supplied; and removing a raffinate stream downstream from another one of the columns. The method includes flowing fluid in a third flow configuration in which the liquid flows through the first, second, third and fourth columns in an absence of a supply of additional feed mixture and an absence of a supply of additional desorbent to the liquid flow.

In some embodiments, the third flow configuration further comprises an absence of a removal of fluid from the plurality of columns.

In some embodiments, the steps of flowing fluid in the first, second and third flow configurations are repeated thereby increasing a percentage of the first, second and third components in the raffinate steam, intermediate stream and extract stream, respectively.

In some embodiments, the method includes flowing fluid in a fourth flow configuration in which the valve is in a position that permits fluid flow, the fourth flow configuration comprising: supplying a desorbent to one of the columns that is different than the column to which desorbent is supplied in the second fluid flow configuration and removing an extract stream comprising greater than 50% of the third component downstream from the column to which the desorbent is supplied; and removing a raffinate stream comprising greater than 50% of the first component downstream from another one of the columns. The step of flowing fluid in the second configuration may be after the step of flowing fluid may be after the first flow configuration, the step of flowing fluid in the fourth flow configuration may be after the step of flowing fluid in the second flow configuration, and the step of flowing fluid in the third flow configuration may be after flowing fluid in the fourth flow configuration.

In some embodiments, the step of flowing fluid in the second flow configuration may be after the step of flowing fluid in the first flow configuration, the step of flowing fluid in the third flow configuration may after the step of flowing fluid in the second flow configuration, and the step of flowing fourth in the third flow configuration may be after the step of flowing fluid in the third flow configuration.

In some embodiments step of flowing fluid in the third flow configuration is after the step of flowing fluid in the first flow configuration, the step of flowing fluid in the second flow configuration is after the step of flowing fluid in the third flow configuration, and the step of flowing fluid in the fourth flow configuration is after the step of flowing fluid in the second flow configuration.

In some embodiments, the step of flowing fluid in the second flow configuration is after the step of flowing fluid in the first flow configuration and the step of flowing fluid in the third fluid flow configuration is after the step of flowing fluid in the second configuration. The step of flowing fluid in the third fluid flow configuration may be performed for a time that is longer than the time during which the steps of flowing fluid in the first fluid flow configuration and flowing fluid in the second fluid flow configuration are performed.

In some embodiments, the step of flowing fluid in the third flow configuration is after the step of flowing fluid in the first flow configuration, and the step of flowing fluid in the second flow configuration is after the step of flowing fluid in the third flow configuration. The step of flowing fluid in the third fluid flow configuration may be performed for a time that is longer than the time during which the steps of flowing fluid in the first fluid flow configuration and flowing fluid in the second fluid flow configuration are performed.

In some embodiments, the step of flowing fluid in the third flow configuration is after the step of flowing fluid in the first flow configuration, the step of flowing fluid in the second flow configuration is after the step of flowing fluid in the third flow configuration, and the step of flowing fluid in the third flow configuration is repeated after the step of flowing fluid in the second flow configuration.

In some embodiments, fluid flows sequentially from the first column to the second column, and then to the third column, and then to the fourth column.

In some embodiments, the plurality of columns comprises five or more columns.

In some embodiments, a method of separating a feed mixture comprising at least a first component that interacts with an adsorbent at a low degree of adsorbability, a second component that interacts with the adsorbent at a moderate degree of adsorbability that is more than the low degree of adsorbability, and a third component that interacts with the adsorbent at a high degree of adsorbability that is greater than the low and moderate degrees of adsorbability is provided. The feed mixture is separated in a simulated moving bed that includes a plurality of columns that are configured to permit unidirectional internal liquid flow of a liquid cyclically through the plurality of columns. The method includes: flowing fluid in a first flow configuration comprising: supplying the feed mixture downstream of a valve in a shut off position that stops fluid flow to a first column and supplying a fluid flow from the first column to a second column; supplying a desorbent to a third column that is downstream from the first column and second column and removing an extract stream comprising at least 50% of the third component downstream from the third column; and supplying a desorbent to a fourth column that is downstream from the third column and removing an intermediate stream comprising at least 50% of the second component downstream from the fourth column. The method further includes flowing fluid in a second flow configuration comprising: supplying a desorbent to the third column downstream of a valve in a shut off position and removing an extract stream comprising at least 50% of the third component downstream from the third column to which the desorbent is supplied; and supplying a desorbent to the fourth column downstream of a valve in a shut off position, flowing the liquid through the first and second columns, and removing a raffinate stream comprising at least 50% of the first component downstream from the second column. The method further includes flowing fluid in a third flow configuration in which the liquid flows through the first, second, third and fourth columns in an absence of a supply of additional feed mixture and an absence of a supply of additional desorbent to the liquid flow. The method further includes flowing fluid in a fourth flow configuration comprising: supplying a desorbent to one of the columns and removing a flow stream comprising at least 50% of a selected one of the first, second and third components.

In some embodiments, the step of flowing fluid in the second flow configuration is after the step of flowing fluid in the first flow configuration, the step of flowing fluid in the third flow configuration is after the step of flowing fluid in the second flow configuration, and the step of flowing fluid in the fourth flow configuration is after the step of flowing fluid in the third flow configuration.

In some embodiments, the first flow configuration further comprises removing a raffinate stream comprising the first component downstream from the first column and upstream from the valve.

In some embodiments, during the step of flowing fluid in the first flow configuration, fluid flows from the first column to the second column.

In some embodiments, in the fourth fluid flow configuration, the desorbent is supplied to the second column and removing a flow stream comprising at least 50% of a selected one of the first, second and third components comprises: removing an extract stream comprising at least 50% of the third component downstream from the second column; flowing fluid through the third column and removing an intermediate stream comprising at least 50% of the second component downstream from the third column; and flowing fluid through the fourth and first columns, and removing a raffinate stream comprising at least 50% of the first component downstream from the first column.

In some embodiments, in the fourth fluid flow configuration, a feed mixture is supplied to the first column downstream from a valve in a shut off position, a desorbent is supplied to the third column, and an intermediate stream comprising at least 50% of the second component is extracted from the fourth column.

In some embodiments, in the fourth fluid flow configuration, a desorbent is supplied to the second column downstream from a valve in a shut off position, a desorbent is supplied to the third column downstream from the third column and a raffinate stream comprising at least 50% of the first component is extracted downstream from the first column, an intermediate stream comprising at least 50% of the second component is extracted from the third column, and an extract stream comprising at least 50% of the third component downstream from the second column.

In some embodiments, the plurality of columns comprises five or more columns.

In some embodiments, a device is provided for separating a feed mixture comprising at least a first component that interacts with an adsorbent at a low degree of adsorbability, a second component that interacts with the adsorbent at a moderate degree of adsorbability that is more than the low degree of adsorbability, and a third component that interacts with the adsorbent at a high degree of adsorbability that is greater than the low and moderate degrees of adsorbability. The feed mixture is separated in a simulated moving bed that includes a plurality of columns that are configured to permit unidirectional internal liquid flow of a liquid cyclically through the plurality of columns. The device includes a control circuit configured to control fluid flow in an SMB system, the control circuit being configured to flow fluid in a plurality of flow configurations as described herein.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram of a prior art Simulated Moving Bed (SMB) chromatography system.

FIG. 2A is a schematic diagram of a plurality of columns for SMB configurations according to some embodiments.

FIG. 2B are graphs of operating parameters for the plurality of columns of FIG. 2A.

FIG. 3A is a schematic diagram of a plurality of columns for SMB configurations according to some embodiments.

FIG. 3B are graphs of operating parameters for the plurality of columns of FIG. 3A.

FIG. 4 is a graph of the productivities obtained with respect to the purity of the intermediate component in the intermediate stream of FIGS. 2A-2B and FIGS. 3A-3B as compared to a conventional Five-Zone configuration and a configuration by Japan Organo Co., Ltd (“JO”). The purity of the intermediate component is imposed as a constraint in the throughput maximization calculation.

FIGS. 5-14 are schematic diagrams of operating flow configurations for a plurality of columns according to some embodiments.

FIG. 15 is a schematic diagram of a system, method and computer program product for a controller for controlling the flow configurations according to some embodiments.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under,” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable non-transient storage medium having computer-usable or computer-readable program code embodied in the medium for use by or in connection with an instruction execution system.

The computer-usable or computer-readable medium may be, for example but not limited to, an electronic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

As used herein, the term “SMB” refers to simulated moving bed chromatography.

As used herein, a “feed mixture” or “feed” is a fluid (liquid or gas) that is introduced into a SMB system that includes various products that may be separated by the SMB system. Typically, a feed mixture includes components that are retained by various degrees by the adsorbent. The feed mixture may include any suitable components for separation, such as sugar, petrochemical and pharmaceutical separations.

As used herein, “raffinate” or “raffinate stream” is a product stream pumped from the SMB during operation that generally corresponds to the least retained component or components. The raffinate stream generally contains at least more than 50% by weight of the raffinate component(s), and may contain more than about 80%, 90%, 95% up to 99% or more by weight of the raffinate component(s).

As used herein, “extract” or “extract stream” is a product stream pumped from the SMB during operation that generally corresponds to the most retained component or components. The extract stream generally contains at least more than 50% by weight of the extract component(s), and may contain more than about 80%, 90%, 95% up to 99% or more by weight of the extract component(s).

As used herein, an “intermediate” or “intermediate stream” is a product stream pumped from the SMB during operation that generally corresponds to a component or components that are retained at a degree that is between the most retained component(s) and the least retained component(s). The intermediate stream generally contains at least more than 50% by weight of the intermediate component(s), and may contain more than about 80%, 90%, 95% up to 99% or more by weight of the intermediate component(s).

As used herein, a “desorbent” is an eluent or mobile phase used to carry out the separation by moving a solute through a column in an SMB process. Examples of desorbents include water and methanol.

As used herein, an “adsorbent” is an adsorbing material in the SMB columns that has a particular affinity for a component in an SMB process. Typical adsorbents used in simulated moving bed adsorption processes generally include crystalline aluminosilicate zeolites and can comprise both the natural and synthetic aluminosilicates, silica gel or ion-exchange resins.

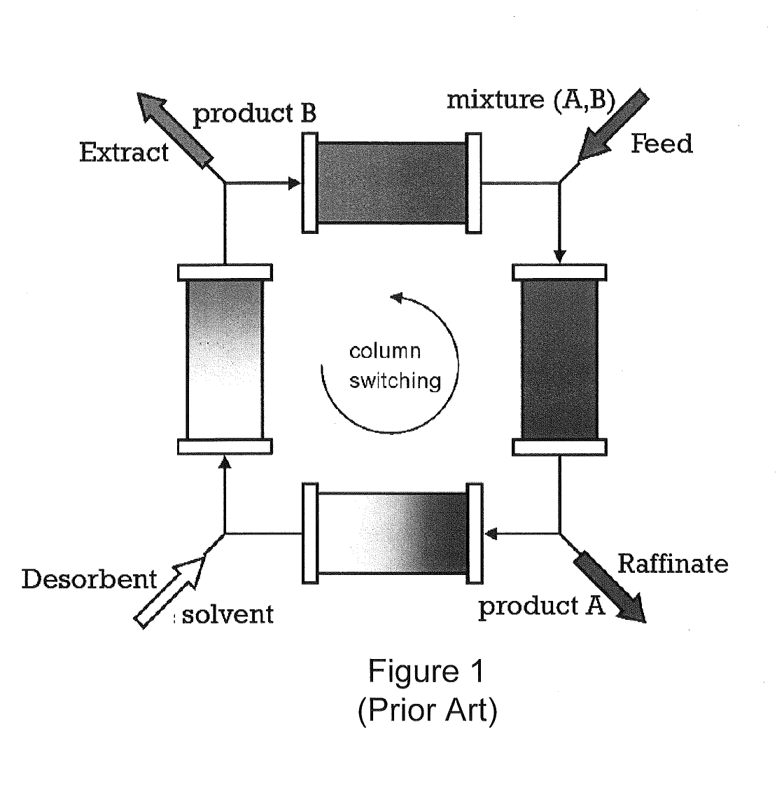

The SMB process generally involves a flow scheme that takes advantage of continuous and counter-current movement of liquid and stationary phases without an actual movement of the solid. As shown in FIG. 1, a conventional SMB unit generally includes multiple chromatographic columns that are interconnected in a cyclic formation. The feed and desorbent are supplied continuously, and at the same time, extract and raffinate streams are drawn continuously through the ports. The feed mixture includes two components that are separated due to their varying affinity towards the adsorbent phase in the columns. The least retained component is recovered from the raffinate while the most retained component is recovered through the extract stream outlet. The two inlet streams, feed and desorbent and two outlet streams, extract and raffinate divide entire SMB systems into four zones. This conventional SMB configuration with four zones has been extensively studied.

According to some embodiments, an SMB system is provided in which complex mixtures of three or more components may be separated. In some embodiments of the invention, the feed mixture is a ternary mixture including components A, B and C, with A as least adsorbable component, B as intermediate and C as most adsorbable component. Hence, the components A, B and C would be dominating in raffinate, intermediate and extract stream outlets, respectively.

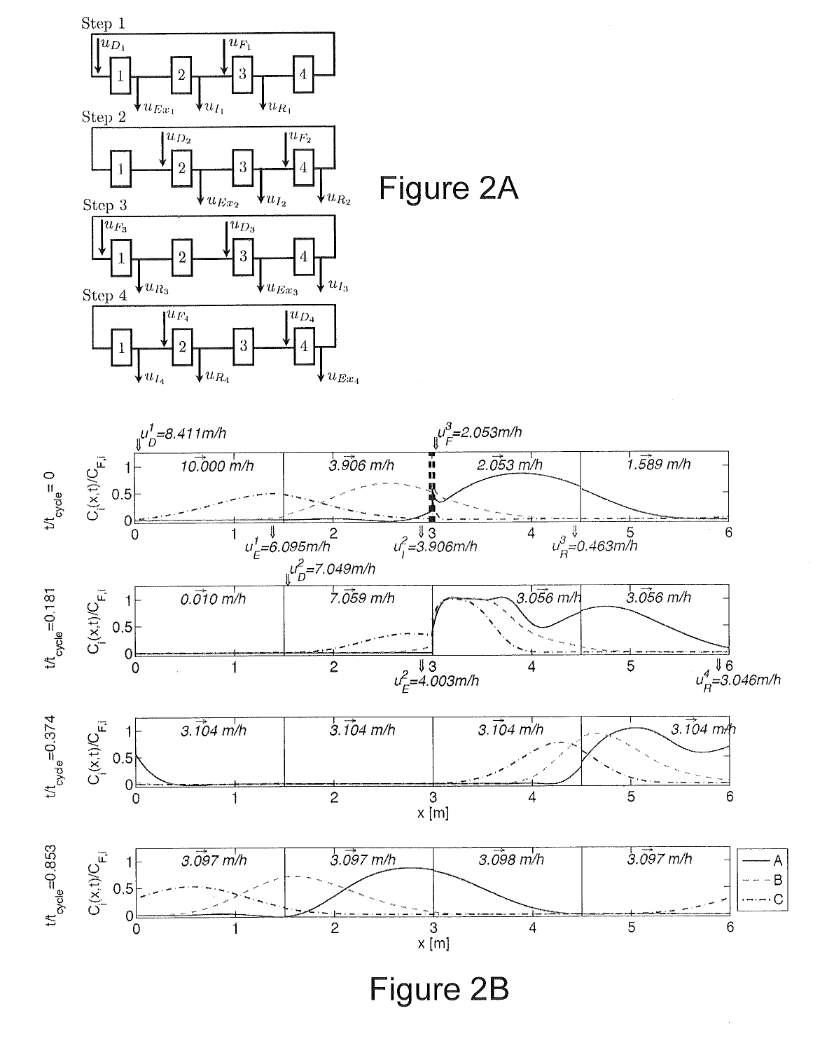

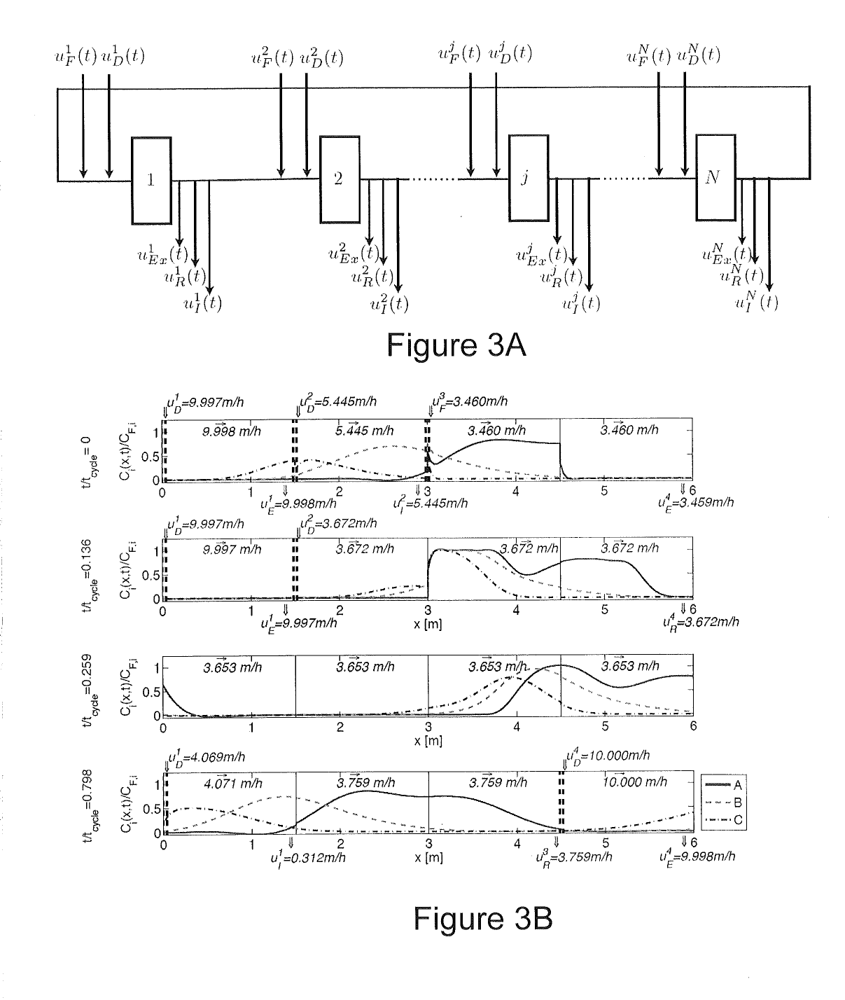

Two operating configuration are shown in FIGS. 2A-2B and FIGS. 3A-3B, respectively. These operating configurations are obtained by forming an optimization problem to find a suitable ternary separation strategy among various possible alternatives of SMB. A schematic of SMB superstructure column formulation has been shown in FIGS. 2A and 3A. The symbols u^{j}_{F}(t) and u^{j}_{D}(t) refer to feed and desorbent inlet velocities of the jth column respectively. The symbols u^{j}_{Ex}(t), u^{j}_{R}(t) and u^{j}ₗ(t) refer to extract, raffinate and intermediate stream outlet velocities of the jth column respectively. The configurations illustrated in FIGS. 2A-2B and FIGS. 3A-3B each include at least four columns connected to each other in a cycle and divided into multiple number of zones by various inlet and outlet streams. The continuous, countercurrent motion of the stationary phase is simulated by switching both inlet and outlet streams in the direction of liquid flow. Hence, a cycle of SMB is repeated after four steps. The concentration profiles inside the SMB column may be identical at the beginning and at the end of the cycle, thus characterized by a cyclic steady state. FIG. 2B and FIG. 3B illustrate the normalized concentration profile within the SMB columns of corresponding FIG. 2A and FIG. 3A, respectively. The solid, dashed and dash-dotted curved lines correspond to the concentrations of components A, B and C, respectively. The two vertical dashed lines, closely spaced to one another, indicate the breaking of the circuit. The purities obtained of components A and B are about 98% and 90%, respectively. The recoveries obtained of components A and B are about 98% and 94%, respectively.

The first configuration is shown in FIGS. 2A-2B along with the normalized concentration profiles at the beginning of each step. The four SMB columns are connected in a cyclic manner separated by the solid vertical lines. The solid, dashed and dash-dotted curved lines correspond to the concentrations of components A, B and C. The two vertical dashed lines, closely spaced to each other, indicate the breaking of the circuit, i.e., stopping the liquid flow into the next column from the previous one. The fraction of the beginning of the steps time are also shown vertically to the left side of FIG. 2B. In the first step, the circuit connecting columns 2 and 3 is broken to recover the pure component B through the intermediate stream outlet. At the same time, components A and C are also recovered from the raffinate and extract stream outlets respectively. In the second step, the pure components C and A are recovered from the extract and raffinate stream outlets at the end of columns 2 and 4 respectively. The third and fourth steps are complete recycle without any inlet and outlet stream and thus allowing concentration profiles to get separated from each other. This cycle of four steps may be continuously repeated in order to obtain products or output streams of the various components of increased purity.

TABLE 1
Throughput Maximization of SMB with a Linear Isotherm
Using Five Zone, JO, the Configuration of FIGS. 2A-
2B, and the Configuration of FIGS. 3A-3B.

| | | | Configuration | Configuration |
|---|---|---|---|---|
| | Five-Zone | JO | of FIGS. 2A-2B | of FIGS. 3A-3B |
| Productivity | 0.0029 | 0.039 | 0.0618 | 0.078 |
| (L-feed/L- | | | | |
| adsorbent/h) | | | | |
| Desorbent to | 687.42 | 9.45 | 7.77 | 14.05 |
| feed ratio | | | | |
| Purity | 98 | 98 | 98 | 98 |
| of A (%) | | | | |
| Recovery | 98 | 98 | 98 | 98 |
| of A (%) | | | | |
| Recovery | 94 | 94 | 94 | 94 |
| of B (%) | | | | |
| Purity | 80 | 80 | 80 | 80 |
| of B (%) | | | | |

The second configuration is shown in FIGS. 3A-3B along with the normalized concentration profiles at the beginning of each step. In the first step, both columns 1 and 2 are isolated by breaking the circuit and then components B and C are purged into their respective outlet streams forcefully by feeding desorbent at the inlet of the first and second column. Hence, column 4 is dominated by component A in the beginning of the second step. The pure components A and B are recovered through the raffinate and intermediate stream outlets during the second step. The discontinuity in the concentration profiles at the end of the second column arises due to the isolation of column 2 in the first step. The third step is a complete recycle with no inlet and outlet streams. This step takes the longest time which is required for the concentration profiles to get separated from each other inside the SMB columns. Any removal stream in the third step would result in the contamination of products. In the fourth step, again purging is performed by isolating column 4 and pure components B and C are recovered. This operating scheme may result in high throughput, however, it may consume a relatively larger amount of dersorbent because of the high amount of purging. Accordingly, such operating schemes of SMB could be very useful in situations where desorbent is inexpensive compared to overall profit obtained from purification of products.

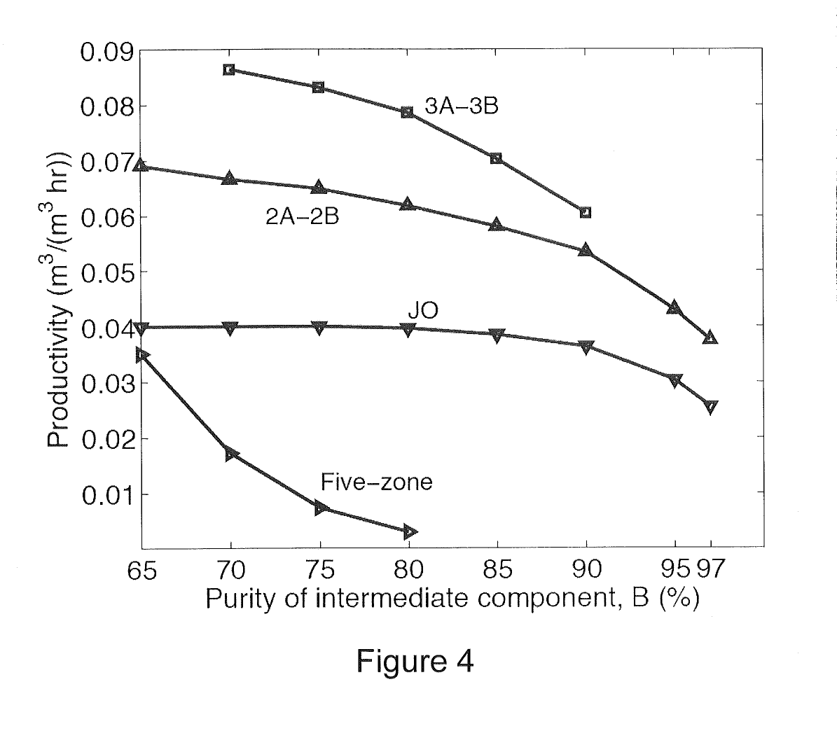

A Pareto plot may be used to compare the configurations of SMB shown in FIGS. 2A-2B and FIGS. 3A-3B with the other existing ternary separation techniques. The throughput of SMB obtained is translated in terms of productivity which is defined as the volume fed to the SMB process per unit volume of the adsorbent per unit time. The results are shown in FIG. 4. Further, a comparison of objective function values is summarized in Table 1 and includes a five-zone SMB cascade and a prior configuration perfected by Japan Organo Co., Ltd (See U.S. Pat. No. 5,198,120)(“JO”). This comparison corresponds to the case in which 80 percent purity of intermediate component is obtained. As it can be seen, the five-zone SMB cascade would be least preferred for ternary separation because of its low productivity. On the other hand, JO, the configuration of FIGS. 2A-2B and the configuration of FIGS. 3A-3B are more advantageous from an economic point of view. There may be up to 100 percent increase in the productivity obtained from embodiments according to the present invention as shown in FIGS. 2A-2B and FIGS. 3A-3B compared to the conventional JO process.

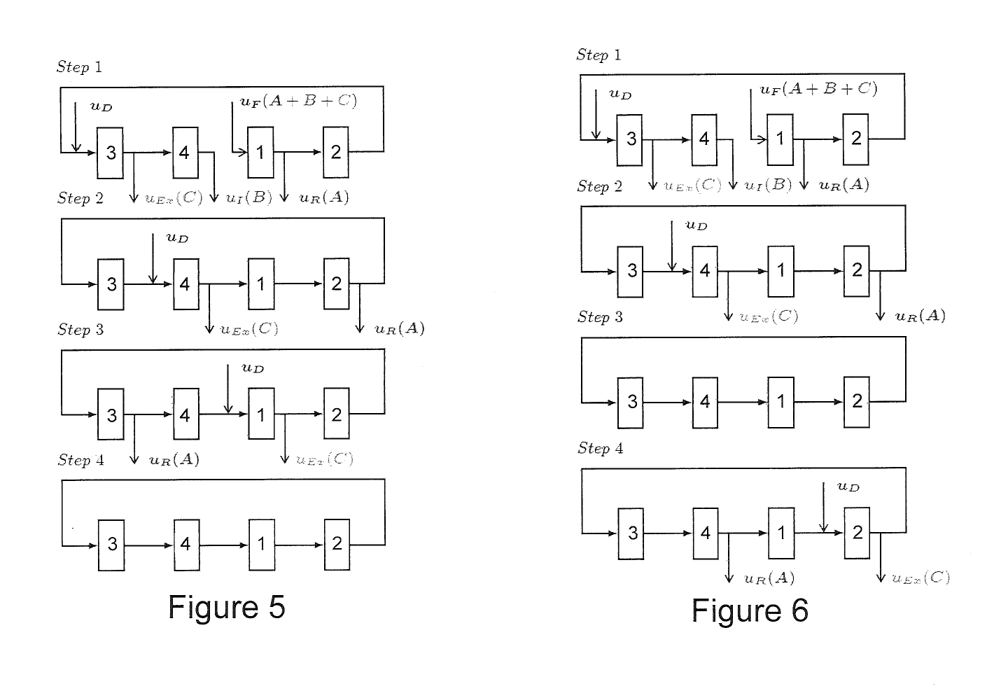

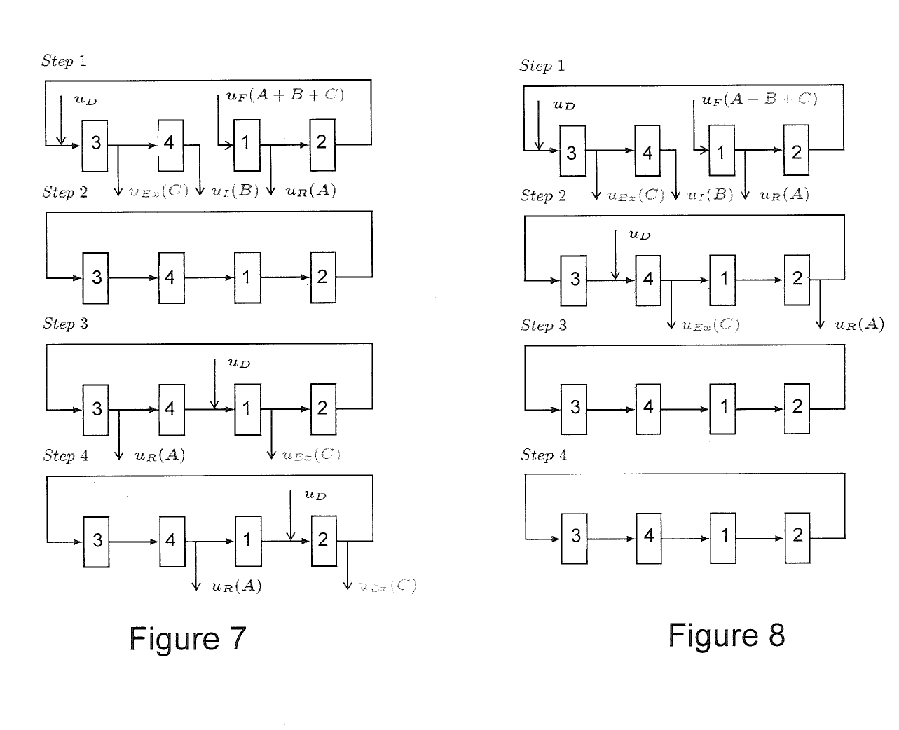

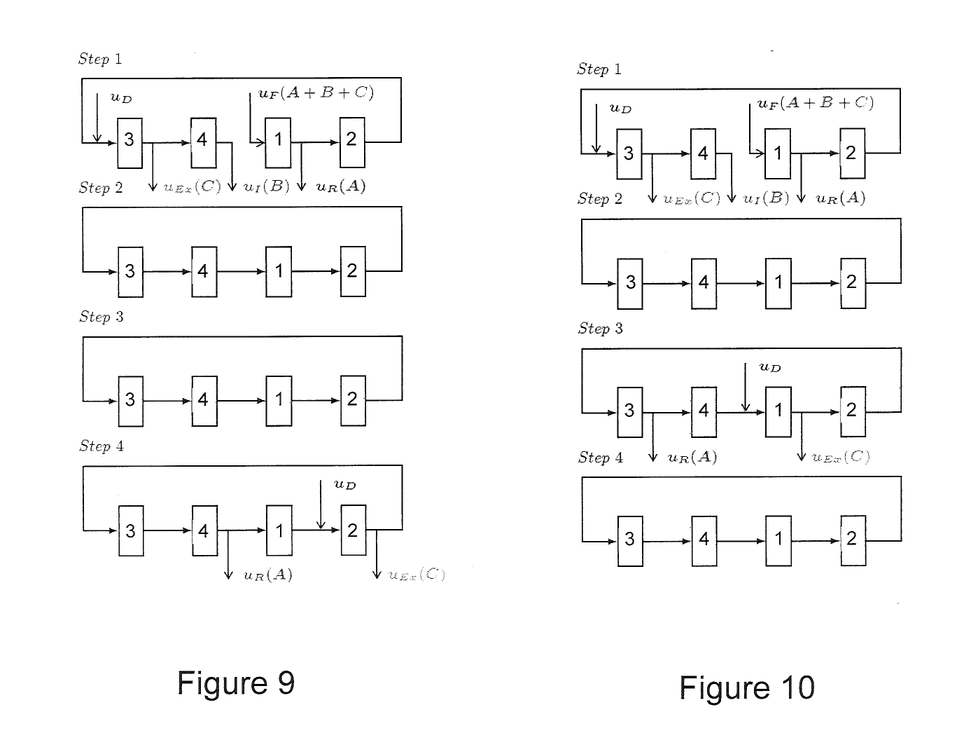

Additional embodiments of the operations shown in FIGS. 2A-2B are shown in FIGS. 5-10. The first step or flow configuration includes shutting down the liquid circulation and withdrawing the intermediate retained component on the upstream side of a shut-off valve (see FIG. 5). The feed mixture is continuously fed downstream of the shut-off valve in order to move the concentration profiles in the columns. The extract and raffinate streams are also withdrawn simultaneously to recover the least and most retained components from the SMB system. The second, third and fourth step (or flow configurations), on the other hand, are combinations of two different scenarios. The first scenario includes feeding the desorbent solution and withdrawing the extract and raffinate streams to recover the least and most retained components (e.g., steps 2 and 3 in FIG. 5). The second scenario includes pure liquid circulation inside the SMB system without any addition or removal of the feed or product streams with the shut-off valve closed (e.g., step 4 in FIG. 5). The second scenario may provide time for concentration profiles of various components to separate from each other. It is also possible for the second scenario to be used more than once during a cycle. Accordingly, various specific embodiments of SMB operating schemes are shown in FIG. 5-10.

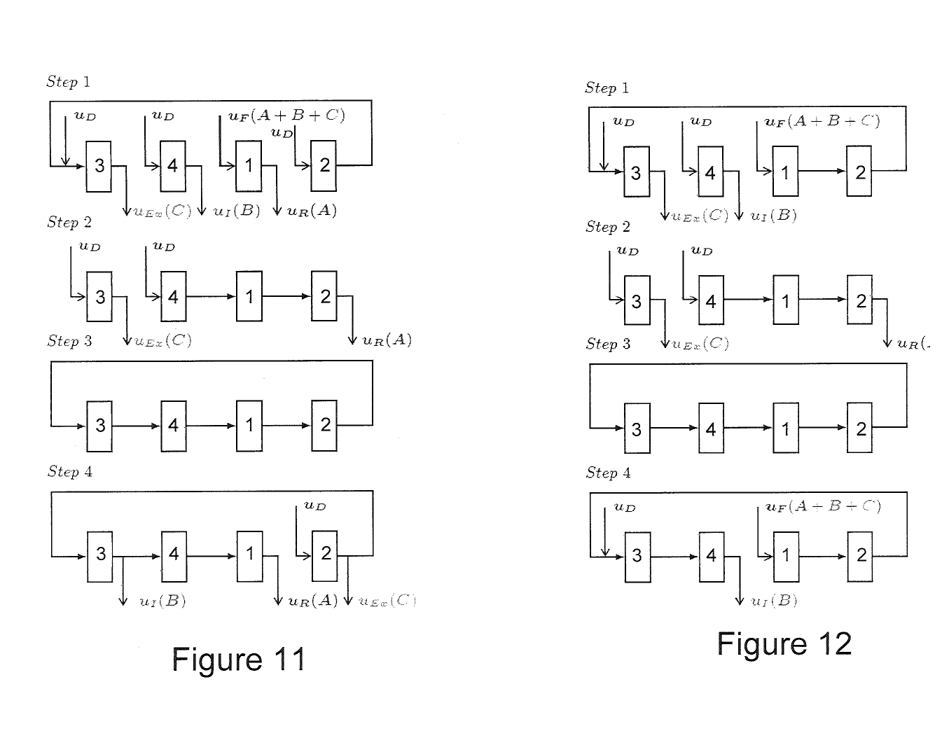

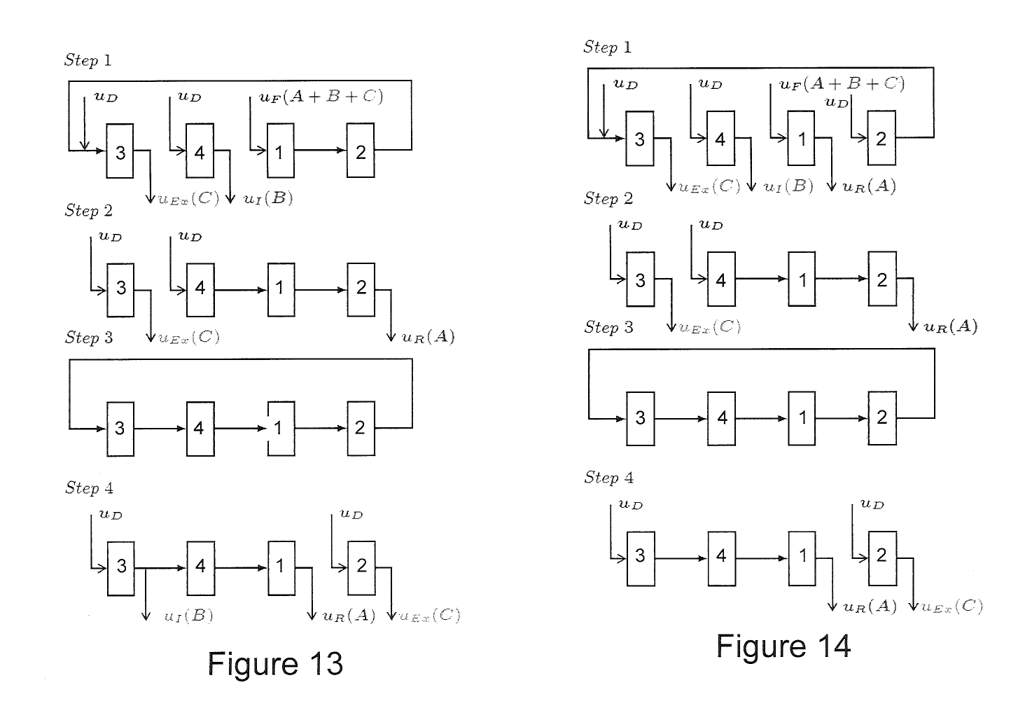

Particular embodiments of the operations shown in FIGS. 3A-3B are shown in FIGS. 11-14 and include four steps where different operations are performed in different steps. As illustrated in FIG. 11, the first step or flow configuration includes shutting down the liquid circulation at three different locations between columns and purging the most retained, intermediate and least retained components into extract, intermediate and raffinate streams, respectively, by feeding the desorbent or the feed solution at the inlet of the isolated columns (see FIG. 11). The second step or flow configuration includes isolating a chromatographic column by shutting down the liquid circulation and purging the most retained component downstream into the extract stream outlet by feeding the desorbent solution at the inlet of column. The desorbent solution is also fed downstream of a shut-off valve to recover the least retained component through the raffinate stream. The third step or flow configuration includes circulating the liquid flow inside the SMB columns. There is no feed solution or the product streams added or withdrawn from the system during this step. The fourth step or flow configuration could be operated in three different ways. In general, in the fourth step, a desorbent is supplied to one of the columns and either a raffinate, extract or intermediate stream is obtained. The first scenario includes shutting down the liquid circulation and recovering the least retained component from the raffinate stream on the downstream side. The desorbent solution is fed downstream to recover the most and intermediate retained component in extract and intermediate streams, respectively (see FIGS. 11-12). The second scenario includes shutting down the liquid circulation and recovering the intermediate retained component from the downstream side. The feed solution is fed on the downstream side of the shut-off position as shown in FIG. 13. The third scenario is comprised of isolating a chromatographic column by shutting down the liquid circulation and purging the most retained component in the extract stream by feeding the desorbent solution at the inlet of the column (see FIG. 14). The desorbent solution is also fed on the downstream side to recover the intermediate and the least retained components in the intermediate and the raffinate streams, respectively.

Although any suitable parameters may be used, typical flow rates may be greater than zero and less than and about 10 m/h, and the switching times between flow configurations may be greater than zero and less than 5000 seconds.

Although embodiments are described herein with respect to various sequential and cyclical steps, it should be understood that the flow configurations shown in FIGS. 5-14 may be initiated at any of the steps. Moreover, the steps may be performed in a different order from that illustrated.

In addition, although particular embodiments are described with respect to four columns in an SMB system, it should be understood that five or more columns may be used. Stated otherwise, any of the columns of the SMB system and methods described herein may be replaced or divided into two or more columns such that the operations upstream and downstream of the column shown are instead performed upstream or downstream of two or more columns.

Some embodiments according to the invention are described with respect to a ternary mixture having three components. It should be understood, however, that more than three components may be separated in the SMB system and methods described herein. Accordingly, the extract stream, intermediate stream and/or raffinate stream may include two or more components. In some embodiments, an extract stream, intermediate stream and/or raffinate stream having two or more components may be further separated using conventional SMB or the SMB system and methods described herein.

Some embodiments of SMB configurations described herein may be useful for sugar, petrochemical and pharmaceutical separations.

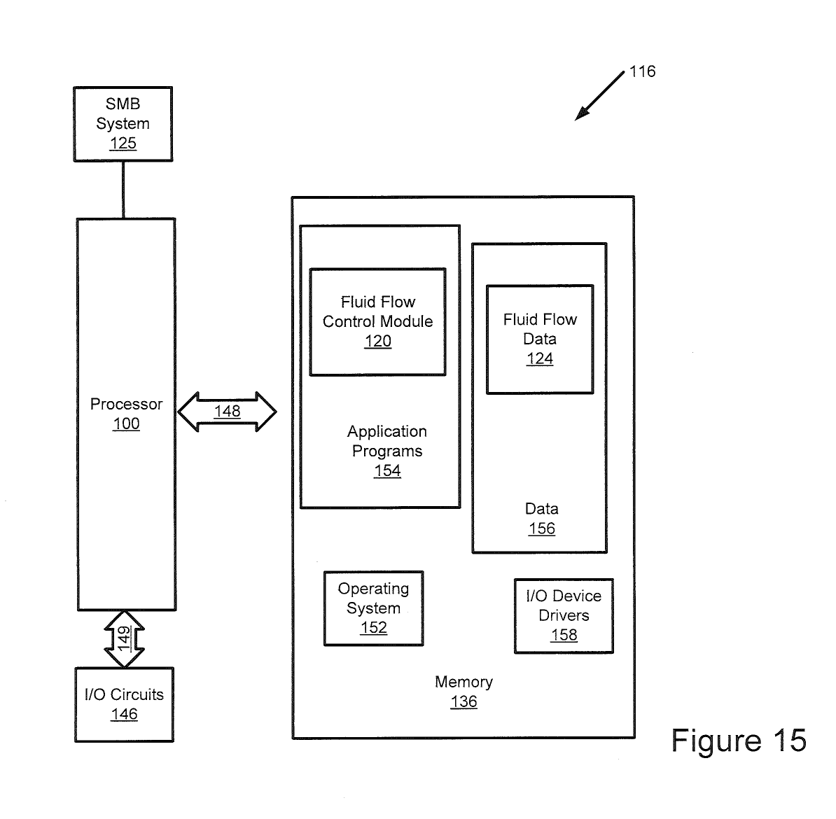

FIG. 15 illustrates an exemplary data processing system that may be included in devices operating in accordance with some embodiments of the present invention, e.g., to carry out the operations illustrated in FIGS. 2-14, e.g., to control an SMB system, including valve controllers and/or fluid supply controllers for changing the flow rates of fluids added to the SMB system as described herein. As illustrated in FIG. 15, a data processing system 116, which can be used to carry out or direct operations includes a processor 100, a memory 136 and input/output circuits 146. The data processing system can be incorporated in a portable communication device and/or other components of a network, such as a server. The processor 100 communicates with the memory 136 via an address/data bus 148 and communicates with the input/output circuits 146 via an address/data bus 149. The input/output circuits 146 can be used to transfer information between the memory (memory and/or storage media) 136 and another component, such as SMB system 125 (e.g., an SMB system as described herein having an automated controller for controlling the addition of desorbants, feed mixtures and the like and for controlling the extraction of a raffinate, intermediate or extract stream from the fluid flow). These components can be conventional components such as those used in many conventional data processing systems, which can be configured to operate as described herein.

In particular, the processor 100 can be a commercially available or custom microprocessor, microcontroller, digital signal processor or the like. The memory 136 can include any memory devices and/or storage media containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 can be a content addressable memory (CAM).

As further illustrated in FIG. 15, the memory (and/or storage media) 136 can include several categories of software and data used in the data processing system: an operating system 152; application programs 154; input/output device circuits 146; and data 156. As will be appreciated by those of skill in the art, the operating system 152 can be any operating system suitable for use with a data processing system, such as IBM®, OS/2®, AIX® or zOS® operating systems or Microsoft® Windows® operating systems Unix or Linux™. The input/output device circuits 146 typically include software routines accessed through the operating system 152 by the application program 154 to communicate with various devices. The application programs 154 are illustrative of the programs that implement the various features of the circuits and modules according to some embodiments of the present invention. Finally, the data 156 represents the static and dynamic data used by the application programs 154, the operating system 152 the input/output device circuits 146 and other software programs that can reside in the memory 136.

The data processing system 116 can include several modules, including a fluid flow control module 120 and the like. The modules can be configured as a single module or additional modules otherwise configured to implement the operations described herein for fluid flow control in the SMB system. The data 156 can include fluid control data 124, for example, that can be used by the fluid control module 120 to provide instructions to the SMB system 125 to carry out the fluid flow configurations described herein.

While the present invention is illustrated with reference to the fluid flow control module 120 and the fluid flow control data 124 in FIG. 15, as will be appreciated by those of skill in the art, other configurations fall within the scope of the present invention. For example, rather than being an application program 154, these circuits and modules can also be incorporated into the operating system 152 or other such logical division of the data processing system. Furthermore, while the fluid control module 120 in FIG. 15 is illustrated in a single data processing system, as will be appreciated by those of skill in the art, such functionality can be distributed across one or more data processing systems. Thus, the present invention should not be construed as limited to the configurations illustrated in FIG. 15, but can be provided by other arrangements and/or divisions of functions between data processing systems. For example, although FIG. 15 is illustrated as having various circuits and modules, one or more of these circuits or modules can be combined, or separated further, without departing from the scope of the present invention. In some embodiments, the operating system 152, programs 154 and data 156 may be provided as an integrated part of the SMB system 125.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of separating a feed mixture comprising at least a first component that interacts with an adsorbent at a low degree of adsorbability, a second component that interacts with the adsorbent at a moderate degree of adsorbability that is more than the low degree of adsorbability, and a third component that interacts with the adsorbent at a high degree of adsorbability that is greater than the low and moderate degrees of adsorbability, wherein the feed mixture is separated in a simulated moving bed that includes a plurality of columns that are configured to permit unidirectional internal liquid flow of a liquid cyclically through the plurality of columns, the method comprising:
flowing fluid in a first flow configuration comprising:
supplying the feed mixture downstream of a valve in a shut off position that stops fluid flow to a first column, removing a raffinate stream comprising greater than 50% of the first component downstream from the first column, and supplying a remaining fluid flow to a second column;
supplying a desorbent to a third column that is downstream from the first column and removing an extract stream comprising greater than 50% of the third component downstream from the third column; and
passing a remaining liquid flow through a fourth column, and removing an intermediate stream comprising greater than 50% of the second component downstream from the fourth column;
flowing fluid in a second flow configuration in which the valve is in a position that permits fluid flow to the first column, the second flow configuration comprising:
supplying a desorbent to one of the columns and removing an extract stream comprising greater than 50% of the third component downstream from the column to which the desorbent is supplied; and
removing a raffinate stream comprising greater than 50% of the first component downstream from another one of the columns;
flowing fluid in a third flow configuration in which the liquid flows through the first, second, third and fourth columns in an absence of a supply of additional feed mixture and an absence of a supply of additional desorbent to the liquid flow.

2. The method of claim 1, wherein the third flow configuration further comprises an absence of a removal of fluid from the plurality of columns.

3. The method of claim 1, further comprising repeating the steps of flowing fluid in the first, second and third flow configurations thereby increasing a percentage of the first, second and third components in the raffinate steam, intermediate stream and extract stream, respectively.

4. The method of claim 1, further comprising flowing fluid in a fourth flow configuration in which the valve is in a position that permits fluid flow, the fourth flow configuration comprising:
supplying a desorbent to one of the columns that is different than the column to which desorbent is supplied in the second fluid flow configuration and removing an extract stream comprising greater than 50% of the third component downstream from the column to which the desorbent is supplied; and
removing a raffinate stream comprising greater than 50% of the first component downstream from another one of the columns.

5. The method of claim 4, wherein the step of flowing fluid in the second configuration is after the step of flowing fluid in the first flow configuration, the step of flowing fluid in the fourth flow configuration is after the step of flowing fluid in the second flow configuration, and the step of flowing fluid in the third flow configuration is after flowing fluid in the fourth flow configuration.

6. The method of claim 4, wherein the step of flowing fluid in the second flow configuration is after the step of flowing fluid in the first flow configuration, the step of flowing fluid in the third flow configuration is after the step of flowing fluid in the second flow configuration, and the step of flowing fourth in the third flow configuration is after the step of flowing fluid in the third flow configuration.

7. The method of claim 4, wherein the step of flowing fluid in the third flow configuration is after the step of flowing fluid in the first flow configuration, the step of flowing fluid in the second flow configuration is after the step of flowing fluid in the third flow configuration, and the step of flowing fluid in the fourth flow configuration is after the step of flowing fluid in the second flow configuration.

8. The method of claim 4, wherein the step of flowing fluid in the second flow configuration is after the step of flowing fluid in the first flow configuration and the step of flowing fluid in the third fluid flow configuration is after the step of flowing fluid in the second configuration.

9. The method of claim 8, wherein the step of flowing fluid in the third fluid flow configuration is performed for a time that is longer than the time during which the steps of flowing fluid in the first fluid flow configuration and flowing fluid in the second fluid flow configuration are performed.

10. The method of claim 1, wherein the step of flowing fluid in the third flow configuration is after the step of flowing fluid in the first flow configuration, and the step of flowing fluid in the second flow configuration is after the step of flowing fluid in the third flow configuration.

11. The method of claim 10, wherein the step of flowing fluid in the third fluid flow configuration is performed for a time that is longer than the time during which the steps of flowing fluid in the first fluid flow configuration and flowing fluid in the second fluid flow configuration are performed.

12. The method of claim 1, wherein the step of flowing fluid in the third flow configuration is after the step of flowing fluid in the first flow configuration, the step of flowing fluid in the second flow configuration is after the step of flowing fluid in the third flow configuration, and the step of flowing fluid in the third flow configuration is repeated after the step of flowing fluid in the second flow configuration.

13. The method of claim 1, wherein fluid flows sequentially from the first column to the second column, and then to the third column, and then to the fourth column.

14. The method of claim 1, wherein the plurality of columns comprises five or more columns.

15. A method of separating a feed mixture comprising at least a first component that interacts with an adsorbent at a low degree of adsorbability, a second component that interacts with the adsorbent at a moderate degree of adsorbability that is more than the low degree of adsorbability, and a third component that interacts with the adsorbent at a high degree of adsorbability that is greater than the low and moderate degrees of adsorbability, wherein the feed mixture is separated in a simulated moving bed that includes a plurality of columns that are configured to permit unidirectional internal liquid flow of a liquid cyclically through the plurality of columns, the method comprising:
flowing fluid in a first flow configuration comprising:
supplying the feed mixture downstream of a valve in a shut off position that stops fluid flow to a first column and supplying a fluid flow from the first column to a second column;
supplying a desorbent to a third column that is downstream from the first column and second column and removing an extract stream comprising at least 50% of the third component downstream from the third column; and
supplying a desorbent to a fourth column that is downstream from the third column and removing an intermediate stream comprising at least 50% of the second component downstream from the fourth column;
flowing fluid in a second flow configuration comprising:
supplying a desorbent to the third column downstream of a valve in a shut off position and removing an extract stream comprising at least 50% of the third component downstream from the third column to which the desorbent is supplied; and
supplying a desorbent to the fourth column downstream of a valve in a shut off position, flowing the liquid through the first and second columns, and removing a raffinate stream comprising at least 50% of the first component downstream from the second column;
flowing fluid in a third flow configuration in which the liquid flows through the first, second, third and fourth columns in an absence of a supply of additional feed mixture and an absence of a supply of additional desorbent to the liquid flow; and
flowing fluid in a fourth flow configuration comprising:
supplying a desorbent to one of the columns and removing a flow stream comprising at least 50% of a selected one of the first, second and third components.

16. The method of claim 15, wherein the step of flowing fluid in the second flow configuration is after the step of flowing fluid in the first flow configuration, the step of flowing fluid in the third flow configuration is after the step of flowing fluid in the second flow configuration, and the step of flowing fluid in the fourth flow configuration is after the step of flowing fluid in the third flow configuration.

17. The method of claim 16, wherein the first flow configuration further comprises removing a raffinate stream comprising the first component downstream from the first column and upstream from the valve.

18. The method of claim 15, wherein during the step of flowing fluid in the first flow configuration, fluid flows from the first column to the second column.

19. The method of claim 16, wherein, in the fourth fluid flow configuration, the desorbent is supplied to the second column and removing a flow stream comprising at least 50% of a selected one of the first, second and third components comprises:
removing an extract stream comprising at least 50% of the third component downstream from the second column;
flowing fluid through the third column and removing an intermediate stream comprising at least 50% of the second component downstream from the third column; and
flowing fluid through the fourth and first columns, and removing a raffinate stream comprising at least 50% of the first component downstream from the first column.

20. The method of claim 18, wherein, in the fourth fluid flow configuration, a feed mixture is supplied to the first column downstream from a valve in a shut off position, a desorbent is supplied to the third column, and an intermediate stream comprising at least 50% of the second component is extracted from the fourth column.

21. The method of claim 18, wherein, in the fourth fluid flow configuration, a desorbent is supplied to the second column downstream from a valve in a shut off position, a desorbent is supplied to the third column downstream from the third column and a raffinate stream comprising at least 50% of the first component is extracted downstream from the first column, an intermediate stream comprising at least 50% of the second component is extracted from the third column, and an extract stream comprising at least 50% of the third component downstream from the second column.

22. The method of claim 15, wherein the plurality of columns comprises five or more columns.

23. A device for separating a feed mixture comprising at least a first component that interacts with an adsorbent at a low degree of adsobability, a second component that interacts with the adsorbent at a moderate degree of adsorbability that is more than the low degree of adsobability, and a third component that interacts with the adsorbent at a high degree of adsobability that is greater than the low and moderate degrees of adsobability, wherein the feed mixture is separated in a simulated moving bed that includes a plurality of columns that are configured to permit unidirectional internal liquid flow of a liquid cyclically through the plurality of columns, the device comprising:
a control circuit configured to control fluid flow in an SMB system, the control circuit being configured to flow fluid in a first, second and third flow configuration,
wherein the first flow configuration comprises:
supplying the feed mixture downstream of a valve in a shut off position that stops fluid flow to a first column, removing a raffinate stream comprising greater than 50% of the first component downstream from the first column, and supplying a remaining fluid flow to a second column;
supplying a desorbent to a third column that is downstream from the first column and removing an extract stream comprising greater than 50% of the third component downstream from the third column; and
passing a remaining liquid flow through a fourth column, and removing an intermediate stream comprising greater than 50% of the second component downstream from the fourth column;
wherein, in the second flow configuration, the valve is in a position that permits fluid flow to the first column, and the second flow configuration comprises:
supplying a desorbent to one of the columns and removing an extract stream comprising greater than 50% of the third component downstream from the column to which the desorbent is supplied; and
removing a raffinate stream comprising greater than 50% of the first component downstream from another one of the columns;
wherein, in the third flow configuration, the liquid flows through the first, second, third and fourth columns in an absence of a supply of additional feed mixture and an absence of a supply of additional desorbent to the liquid flow,

24. A device for separating a feed mixture comprising at least a first component that interacts with an adsorbent at a low degree of adsobability, a second component that interacts with the adsorbent at a moderate degree of adsorbability that is more than the low degree of adsobability, and a third component that interacts with the adsorbent at a high degree of adsobability that is greater than the low and moderate degrees of adsobability, wherein the feed mixture is separated in a simulated moving bed that includes a plurality of columns that are configured to permit unidirectional internal liquid flow of a liquid cyclically through the plurality of columns, the device comprising:
a control circuit configured to control fluid flow in an SMB system, the control circuit being configured to flow fluid in a first, second, third and fourth flow configuration,
wherein the first flow configuration comprises:
supplying the feed mixture downstream of a valve in a shut off position that stops fluid flow to a first column and supplying a fluid flow from the first column to a second column;
supplying a desorbent to a third column that is downstream from the first column and second column and removing an extract stream comprising at least 50% of the third component downstream from the third column; and
supplying a desorbent to a fourth column that is downstream from the third column and removing an intermediate stream comprising at least 50% of the second component downstream from the fourth column;
the second flow configuration comprises:
supplying a desorbent to the third column downstream of a valve in a shut off position and removing an extract stream comprising at least 50% of the third component downstream from the third column to which the desorbent is supplied; and
supplying a desorbent to the fourth column downstream of a valve in a shut off position, flowing the liquid through the first and second columns, and removing a raffinate stream comprising at least 50% of the first component downstream from the second column;
wherein, in the third flow configuration, the liquid flows through the first, second, third and fourth columns in an absence of a supply of additional feed mixture and an absence of a supply of additional desorbent to the liquid flow; and
the fourth flow configuration comprises:
supplying a desorbent to one of the columns and removing a flow stream comprising at least 50% of a selected one of the first, second and third components.
